(19) United States
(12) Patent Application Publication
(10) Pub. No.: US 2019/0228605 A1
(43) Pub. Date: Jul. 25, 2019

(54) INFORMATION PROVISION SYSTEM AND PROGRAM

(71) Applicants: Ryuichiro YAO, Tokyo (JP); Takashi MEGURO, Tokyo (JP)

(72) Inventors: Ryuichiro YAO, Tokyo (JP); Takashi MEGURO, Tokyo (JP)

(21) Appl. No.: 16/317,170

(22) PCT Filed: Jul. 12, 2016
(86) PCT No.: PCT/JP2016/070522

§ 371 Date: Jan. 11, 2019

(51) Int. Cl. G07C 13/00

(52) U.S. Cl. CPC G07C 13/00

(57) ABSTRACT

An information providing system includes a distribution device configured to distribute a display information item corresponding to an address information item, a controller configured to link the address information item to an identification information item, a transmitter in a place where an entertainment is held, the transmitter configured to transmit a transmission signal obtained by encoding the identification information item, and a receiving terminal configured to receive the transmission signal from the transmitter and decode the transmission signal into the identification information item. The display information item displays a ranking based on a number of received votes each of entrants for the entertainment has received. The distribution device is configured to update, at predetermined time intervals, the display information item that indicates the ranking based on the number of received votes and to set the address information item to correspond to a plurality of display information items.

### CROSS-REFERENCE TO RELATED APPLICATION

This is a U.S. national phase application under 35 U.S.C. § 371 of International Patent Application No. PCT/JP2016/070522, filed on Jul. 12, 2016, the contents of which are herein incorporated by reference in its entirety.

### TECHNICAL FIELD

The present disclosure relates to an information providing system that provides a plurality of information items and a program.

### BACKGROUND ART

Entertainments such as shows and sports have various ideas to entertain attendances (see, Patent Literature 1: JP2008-161290A, for example).

### SUMMARY

An attendance who enjoys an entertainment desires not only to see an entertainment but also to participate in an entertainment in any way. A promoter of an entertainment also desires that an attendance is unified with the entertainment to enjoy the entertainment. The satisfaction of these desires makes the entertainment more interesting.

The present disclosure has been made in view of the above circumstances, and an object of the present disclosure is to provide an information providing system that can contribute to making the entertainment interesting.

An information providing system according to the present disclosure including:

a distribution device configured to distribute a display information item corresponding to an address information item,

a controller configured to link the address information item to an identification information item,

a transmitter in a place where an entertainment is held, the transmitter configured to transmit a transmission signal encoded from the identification information item, and

a receiving terminal configured to receive the transmission signal transmitted from the transmitter and decode the transmission signal into the identification information item,

wherein the display information item indicates a ranking based on a number of received votes an entrant for the entertainment has received,

wherein the distribution device is configured to update, at predetermined time intervals, the display information item that indicates the ranking based on the number of received votes and to set the address information item to correspond to a plurality of display information items, and

wherein the controller is configured to send to the receiving terminal the address information item corresponding to a latest display information item and linked to the identification information item when the controller receives the identification information item from the receiving terminal.

### BRIEF DESCRIPTION OF DRAWINGS

FIG. 1 is an explanation view showing an overview of an information providing system 10 of Embodiment 1 according to one embodiment of an information providing system of the present disclosure.

FIG. 2 is a block diagram showing a configuration of the information providing system 10.

FIG. 3 is an explanation diagram showing a relationship between each identification information item D1 set in a transmitter 11 and each ranking Ra (address information item A) created by a distribution device 14.

FIG. 4 is a view illustrating one example of a ranking Ra1 displayed on a terminal display portion 44.

FIG. 5 is a view illustrating one example of a ranking Ra2 displayed on the terminal display portion 44.

FIG. 6 is a view illustrating one example of a ranking Ran (n>3) displayed on the terminal display portion 44.

FIG. 7 is a flowchart showing, as one example, a distribution information creating process that is executed by a distribution control portion 51.

FIG. 8 is a flowchart showing, as one example, a linking process that is executed by an arithmetic control portion 31.

FIG. 9 is a flowchart showing, as one example, a transmission process that is executed by a transmission control portion 21.

FIG. 10 is a flowchart showing, as one example, an identification information acquiring process that is executed by a terminal control portion 41.

FIG. 11 is a flowchart showing, as one example, a registered information acquiring process that is executed by the terminal control portion 41.

### DETAILED DESCRIPTION

Hereinafter, an information providing system and a program according to the present disclosure are described with reference to an embodiment and drawings.

### Embodiment 1

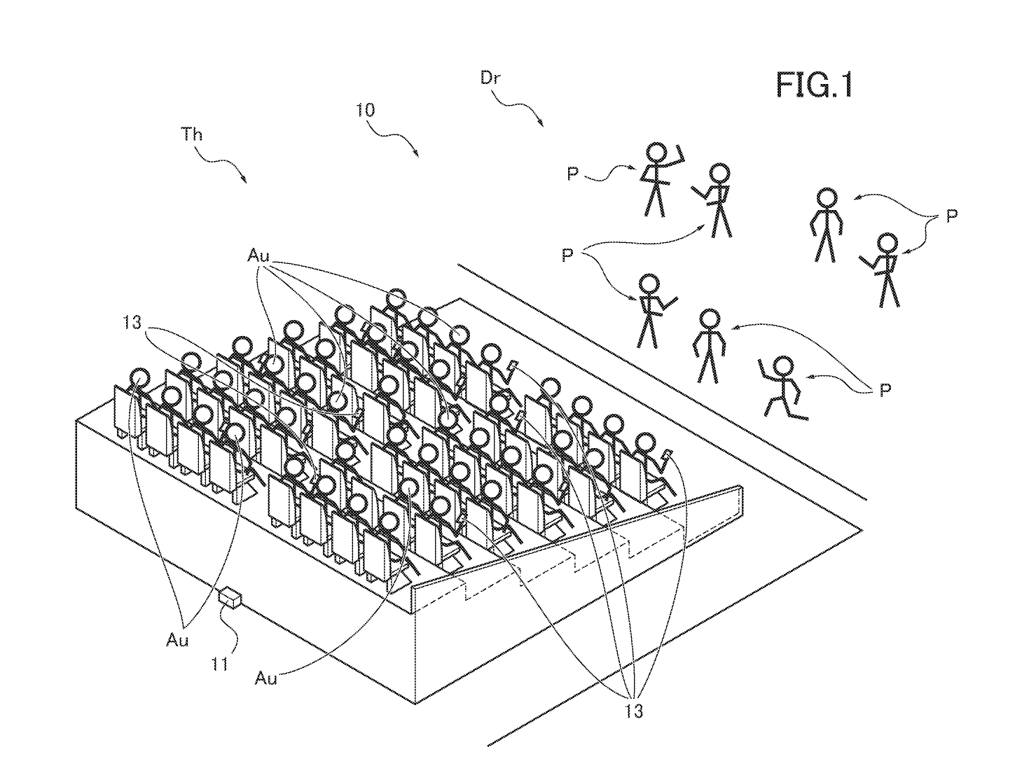

A schematic configuration of an information providing system 10 (a program (application) for use in this system) as one embodiment of the information providing system and the program according to the present disclosure is described with reference to FIGS. 1 to 11.

FIG. 1 shows a simplified theater Th for easily understanding the configuration of the information providing system 10.

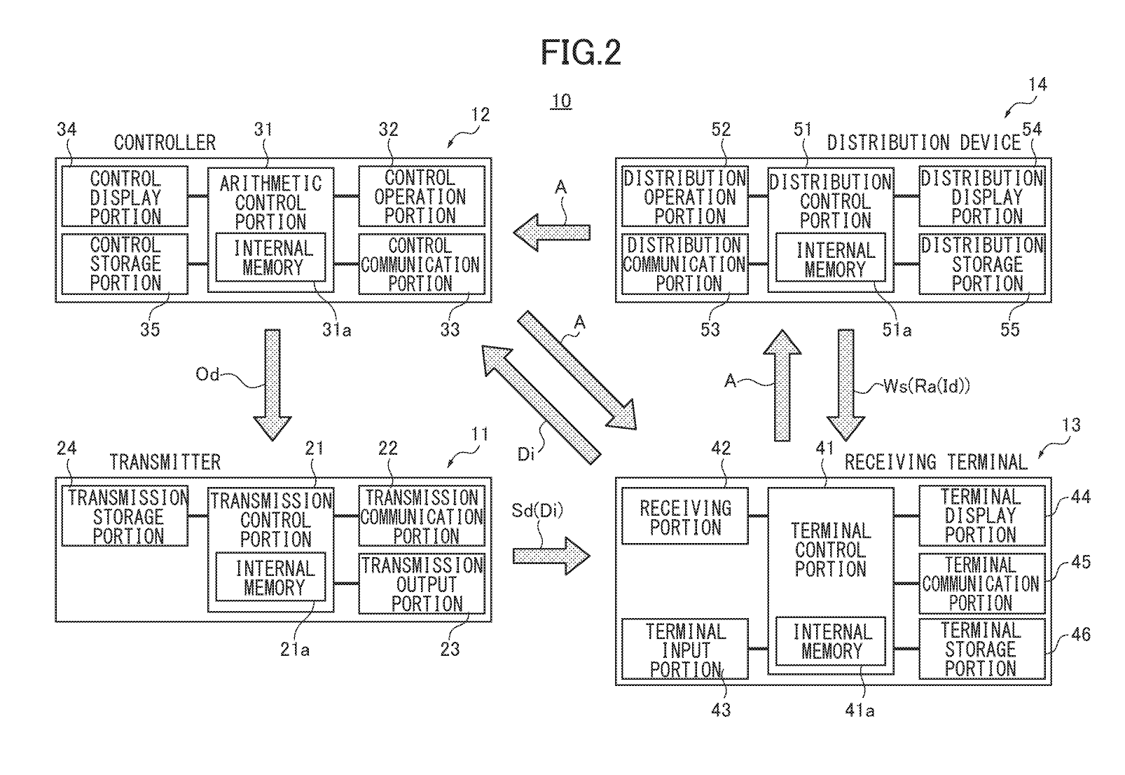

An outline of the information providing system 10 is described with reference to FIGS. 1, 2.

The information providing system 10 contributes to making an event or entertainment such as a show and a sport interesting. A place where such an entertainment is held includes a building (including a site of the building) such as a theater, a cultural complex, a commercial complex, and an outdoor facility (stadium) for various competitions. FIG. 1 shows one example used in a theater Th for a show Dr. In the information providing system 10, a transmitter 11 transmits a transmission signal Sd (refer to FIG. 2), and a receiving terminal 13 of each attendance Au receives the transmission signal Sd. In the information providing system 10, the single transmitter 11 can simultaneously (at the same time) transmit only one type of the transmission signals Sd. In the information providing system 10 of Embodiment 1, a plurality of transmittable transmission signals Sd (namely, the after-described identification information items Di) is set in the transmitter 11, and the transmitter 11 transmits the transmission signals Sd (identification information items Di) in order, so that each receiving terminal 13 receives a plurality of information items.

The information providing system 10 includes the transmitter 11, a controller 12 (refer to FIG. 2), the receiving terminal 13, and a distribution device 14. The transmitter 11 is provided in a place (in this example, the theater Th for the show Dr) where an entertainment is held and encodes the after-described identification information item D1 to transmit (output) the transmission signal Sd (refer to FIG. 2). The transmitter 11 is configured to transmit the transmission signal Sd with a short range wireless communication such as Wi-Fi (registered trademark), Near Filed Communication (NFC) (registered trademark), Bluetooth (registered trademark), and sound (onto which a signal is superimposed). Each receiving terminal 13 receives the transmission signal Sd. The transmission signal Sd is obtained by encoding the identification information item Di in accordance with a communication method previously set with the receiving terminals 13. In Embodiment 1, a management frame of Beacon with a Bluetooth Low Energy (registered trademark) wireless communication is used. The transmitter 11 is an appropriately selected information processing device capable of transmitting each transmission signal Sd in which each identification information item Di set in the transmitter 11 is encoded. The transmitter 11 continuously or intermittently transmits an electric wave. In Embodiment 1, the transmitter 11 is configured to intermittently, namely regularly and repeatedly transmit an electric wave in predetermined timing (i.e., Beacon terminal), and transmits the transmission signal Sd as the electric wave. Such a transmitter 11 may be an exclusive terminal, a smartphone, a personal computer, or a touch pad. In Embodiment 1, the transmitter 11 is a small personal computer.

As illustrated in FIG. 2, the transmitter 11 includes a transmission control portion 21, a transmission communication portion 22, a transmission output portion 23, and a transmission storage portion 24. The transmission control portion 21 integrally executes the following respective processes based on a program stored in the transmission storage portion 24 or a built-in internal memory 21a. The respective processes include a process (acquiring process) of acquiring the after-described transmission operation Od by the transmission communication portion 22 and a process (transmission process) of transmitting (outputting) the transmission operation Od and the transmission signal Sd from the transmission output portion 23 at the after-described time intervals.

The transmission communication portion 22 sends each identification information item Di (refer to FIG. 2), which is set in the transmitter 11, to the controller 12 (the after-described control operation portion 32), and acquires the after-described transmission operation Od from the controller 12 (control operation portion 32). The transmission output portion 23 outputs the transmission signal Sd, which is created with the management frame of Beacon with the Bluetooth Low Energy wireless communication method, by the transmission control portion 21. The transmission output portion 23 transmits each transmission signal Sd, in which each identification information item Di set in the transmitter 11 is encoded, in previously set order at previously set time intervals under the control of the transmission control portion 21. The time intervals and order may be set in the manufacturing step of the transmitter 11 or may be set by the command from the controller 12 (the after-described arithmetic control portion 31). In Embodiment 1, the transmission communication portion 22 and the transmission output portion 23 are integrated by a communication terminal of a Universal Serial Bus (USB) (registered trademark) type, and are connected to a main body of a small personal computer constituting the transmitter 11.

The transmission storage portion 24 stores a readable program for each process and each transmission signal Sd, and appropriately stores the readable time intervals changed by the after-described transmission operation Od, under the control of the transmission control portion 21. In Embodiment 1, the transmission storage portion 24 stores a program for constituting the information providing system 10 with the transmitter 11, the controller 12, each receiving terminal 13, and the distribution device 14. In Embodiment 1, the transmission storage portion 24 stores an application for the transmission process of transmitting the transmission signal Sd.

The controller 12 links a plurality of identification information items Di set in the transmitter 11 to a plurality of address information items A set in the after-described distribution device 14. The address information item A represents the address of a website Ws for displaying the after-described display information item Id (ranking Ra) of the distribution device 14. When the after-described display information item Id (ranking Ra) is created, the controller 12 links the identification information item Di to the address information item A (website Ws) for displaying the display information item (linking process). In this case, the identification information item Di is shown by the transmission signal Sd which is transmitted first in the time series in the unlinked identification information items Di. Accordingly, the controller 12 links the address information item A (website Ws), which corresponds to the latest display information item Id (ranking Ra) of the display information items Id to be updated as described later, to the latest transmission signal Sd (identification information item Di) to be transmitted from the transmitter 11.

As illustrated in FIG. 2, the controller 12 includes an arithmetic control portion 31, a control operation portion 32, a control communication portion 33, a control display portion 34, and a control storage portion 35. In Embodiment 1, the controller 12 is a computer in which a program is stored in the control storage portion 35. The program may be stored in an internal memory 31a of the arithmetic control portion 31.

The arithmetic control portion 31 integrally executes the following respective processes based on the program stored in the control storage portion 35 or the built-in internal memory 31a. The following respective processes include a setting process and an execution process based on the operation to the control operation portion 32, an acquiring process and an output process of data through the control communication portion 33, a driving control process of the control display portion 34, and the linking process of each identification information item Di. The arithmetic control portion 31 includes an operation of displaying, on the control display portion 34, a screen for various setting and execution with the control operation portion 32. The arithmetic control portion 31 appropriately executes the above-described each operation (control) based on the operation to the control operation portion 32 or the program stored in the control storage portion 35 (internal memory 31a).

The control operation portion 32 is used to input each address information item A, link each identification information item Di to each address information item A, and output the transmission operation Od. The transmission operation Od is an operation of transmitting (outputting) the next transmission signal Sd from the transmitter 11 in appropriately set timing. The transmission operation Od can transmit (output) the first transmission signal Sd (start of transmission of each transmission signal Sd), and change the previously set time interval from the transmission of the first transmission signal to the next transmission (outputting) of each transmission signal Sd. In Embodiment 1, the control operation portion 32 is a keyboard connected to a computer and a pointing device such as a mouse. In addition, the control operation portion 32 may be the control display portion 34 with a touch panel.

In order to execute the transmission operation Od, an operation terminal separate from the controller 12 may be used. When the operation terminal can display a screen showing the linkage of each identification information item Di and each address information item A set in the distribution device 14 and a screen showing a relationship with the identification information item Di corresponding to the transmission signal Sd transmitted from the transmitter 11 at this point, such an operation terminal can improve the usability of the operation of the transmission operation Od. When the operation terminal can execute an operation for the linking process of linking each address information item A to each identification information item Di, such an operation terminal can further improve the usability of the information providing system 10. This operation terminal is a computer, for example, a smartphone, including a control portion, an operation portion, a communication portion, a display portion, and a storage portion storing a program.

The control communication portion 33 appropriately acquires data from an external device connected to the controller 12, an internal device built in the controller 12, and a server connected to a network. The data to be acquired includes a plurality of address information items A set in the after-described distribution device 14 and each identification information item Di (refer to FIG. 2) set in the transmitter 11. The external device and the internal device include a data acquiring mechanism that reads data recorded in a recording medium such as a CD. The control communication portion 33 can exchange data with the transmitter 11 (transmission control portion 21) through the transmission communication portion 22, the distribution device 14 (after-described distribution control portion 51) through the after-described distribution communication portion 53, and the receiving terminal 13 (the after-described terminal control portion 41) through the after-described terminal communication portion 45. The exchange data includes a plurality of address information items A set in the distribution device 14 (distribution control portion 51) and each identification information item Di (refer to FIG. 2) set in the transmitter 11.

The control display portion 34 is a liquid crystal display that displays a screen (including a screen for the linking process) showing the linkage of each address information item A (refer to FIG. 2) and each identification information item Di as described later, under the control of the arithmetic control portion 31. The control storage portion 35 stores various readable data and programs under the control of the arithmetic control portion. In Embodiment 1, the control storage portion 35 stores a program for constituting the information providing system 10 with the controller 12, the transmitter 11, each receiving terminal 13, and the distribution device 14. The control storage portion 35 stores an application for the linking process of linking each identification information item Di to each address information item A. The control storage portion 35 appropriately stores the linkage of each identification information item Di and each address information item A.

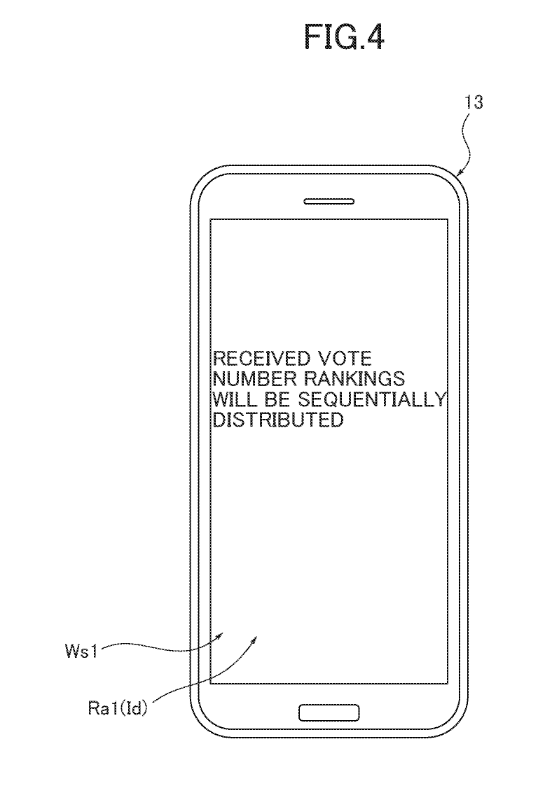

In the information providing system 10, the transmitter 11 transmits the transmission signal Sd showing each identification information item Di to which the address information item A is linked in the controller 12 (arithmetic control portion 31). In the information providing system 10, people in the entertainment (each attendance Au in FIG. 1) can receive the transmission signals Sd transmitted from the transmitter 11 by each receiving terminal 13. The receiving terminal 13 is an information processing device capable of acquiring the transmission signal Sd, decoding the transmission signal Sd into the identification information item Di, and accessing to the website Ws (refer to FIGS. 4 to 6) with the address information item A linked to the identification information item Di and the controller 12 (arithmetic control portion 31). The receiving terminal 13 is, for example, a smartphone, a cellular phone, a personal computer, a touch pad, a console for a game, and an electronic book reader. In Embodiment 1, the receiving terminal 13 is a smartphone.

This receiving terminal 13 includes the terminal control portion 41, a receiving portion 42, a terminal input portion 43, a terminal display portion 44, the terminal communication portion 45, and a terminal storage portion 46. This terminal control portion 41 integrally controls the receiving terminal 13 based on a program stored in the terminal storage portion 46 or the built-in internal memory 41a. Upon acquiring the transmission signal Sd from the receiving portion 42 as described later, the terminal control portion 41 includes the operation of decoding the transmission signal Sd into the identification information item Di and the operation of acquiring the address information item A linked to the identification information item Di from the controller 12 (arithmetic control portion 31) according to the operation to the terminal display portion 44. The terminal control portion 41 can access to a website with an arbitrary address information item, and includes an operation of enabling the browsing of the website relating to the entertainment and the purchasing of goods relating to each entrant (each performer P) on the website selling goods relating to the entertainment.

The receiving portion 42 receives the transmission signal Sd transmitted from the transmission output portion 23 of the transmitter 11. In Embodiment 1, the receiving portion 42 can receive the transmission signal Sd created with the management frame of Beacon with the Bluetooth Low Energy wireless communication method. The receiving portion 42 outputs the received transmission signal Sd to the terminal control portion 41.

The various operations can be executed by the terminal input portion 43. The various operations include the operation of acquiring each address information item A linked to each identification information item D and the operation of accessing to the websites (including website Ws (refer to FIGS. 4 to 6)) with various address information items including each address information item A. In Embodiment 1, the terminal input portion 43 is constituted by the terminal display portion 44 with a touch panel. In addition, the terminal input portion 43 may be a connected key board, a pointing device such as a mouse, and a switch provided in the receiving terminal 13.

The terminal display portion 44 displays a screen for selecting each identification information item Di and various address information items (each address information item A) and an image (including the after-described ranking Ra (refer to FIGS. 4 to 6)) shown by the accessed website (website Ws), under the control of the terminal control portion 41. The terminal communication portion 45 can communicate with an external network, appropriately receives each information item to be stored in the terminal storage portion 46, and appropriately sends each information item stored in the terminal storage portion 46, under the control of the terminal control portion 41. In Embodiment 1, as the receiving terminal 13 is a smartphone, the terminal communication portion 45 can establish a wireless communication, and can exchange the data with the controller 12 (arithmetic control portion 31) through the control communication portion 33 and the distribution device 14 (distribution control portion 51) through the after-described distribution communication portion 53.

The terminal storage portion 46 stores various readable data and programs under the control of the terminal control portion 41. In Embodiment 1, the terminal storage portion 46 stores a program for constituting the information providing system 10 with the receiving terminal 13, the transmitter 11, the controller 12, and the distribution device 14. The terminal storage portion 46 stores an application for an identification information acquiring process of receiving the transmission signal Sd, decoding the received transmission signal Sd into the identification information item Di, and storing the identification information item Di in the terminal storage portion 46, and an application for a registered information acquiring process of acquiring the address information item A linked with the identification information item Di from the controller 12 (arithmetic control portion 31), and displaying the screen for the operation on the terminal display portion 44.

Upon activating the applications, the receiving terminal 13 receives the transmission signal Sd transmitted from the transmitter 11, acquires the identification information item Di into which the transmission signal Sd is decoded, and acquires and displays the address information item A linked to the identification information item Di. The terminal storage portion 46 appropriately stores the identification information item Di and the address information item A acquired by the applications. The receiving terminal 13 can access to the website Ws (refer to FIGS. 4 to 6) with the address information item A by the above configuration. The distribution device 14 distributes the display information item Id (ranking Ra) displayed on the web site Ws.

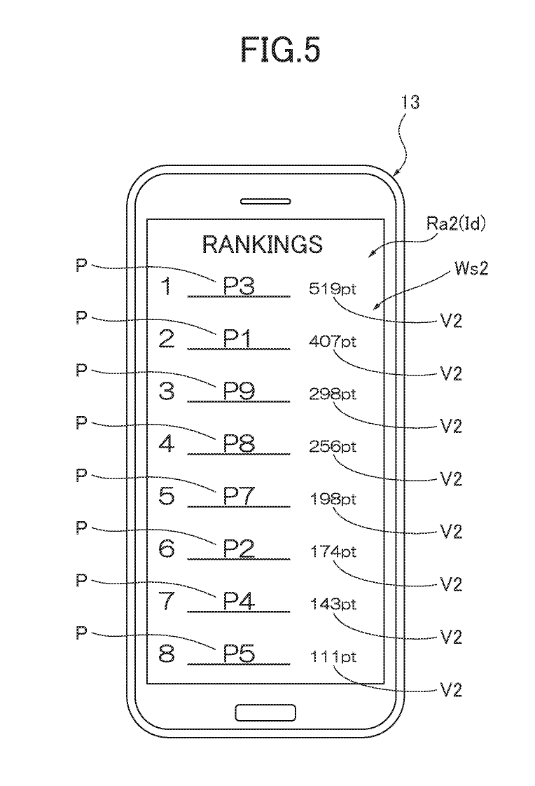

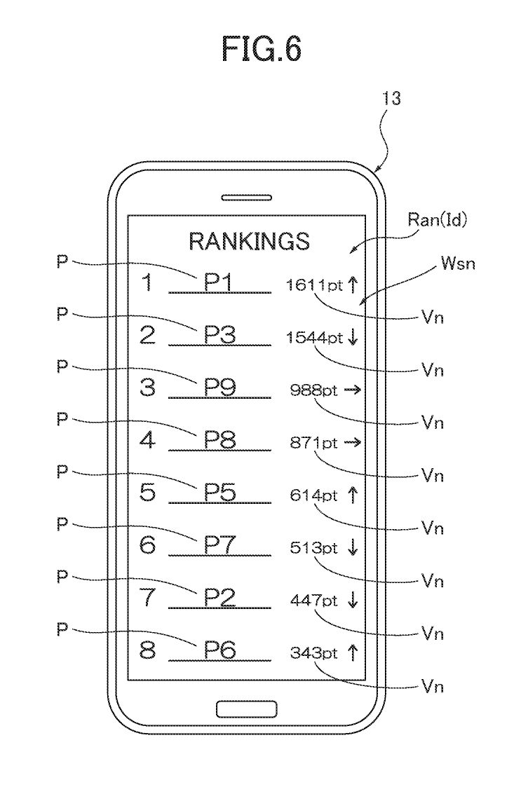

The distribution device 14 is, for example, a web server that distributes the website Ws (webpage (refer to FIGS. 4 to 6)) to the receiving terminal 13, for example. The distribution device 14 sets the display information item Id, and sets the address information item A showing the address of the website Ws for displaying the display information item Id. The display information item Id represents the order (ranking Ra) of each entrant (in this example, each performer P) of the entertainment (in this example, show Dr) based on the number of received votes V (refer to FIGS. 5, 6) during the entertainment (show Dr). Each entrant is a performer P of the show Dr in this embodiment, and is a player when the entertainment is a sport, and is a cast when the entertainment is a movie.

As one example, the number of received votes V includes the number of votes to each entrant (each performer P) in a place where an entertainment is held (in this embodiment, theater Th). This vote may take place with a ballot box placed in that place (theater Th) or with each receiving terminal 13 of each attendance Au. As another example, the number of received votes V is a numerical value based on the number of sales and the sales amount of goods relating to each entrant (each performer P) on the website selling the goods relating to the place (theater Th) and the entertainment. In this case, the number of sales may be the number of received votes V or the sales amount may be the number of received votes V. A point based on the number of sales and the sales amount may be the number of received votes V. The number of sales, the sales amount, and the point may be appropriately combined. In Embodiment 1, the number of votes and the sales of the goods are the number of received votes V. The number of received votes V is calculated for each entrant (performer P) by totaling the points based on the respective parameters.

When the entertainment (show Dr) begins, the distribution device 14 totals the number of received votes V, and determines the order of the number of received votes V for each entrant (each performer P) at predetermined time intervals based on the totalization to create, at predetermined time intervals, the ranking Ra (refer to FIGS. 5, 6) as the display information item Id displaying the order. The distribution device 14 sets the website Ws displaying the ranking Ra (each display information item Id) at predetermined time intervals and each address information item A. As described above, the distribution device 14 executes a distribution information creating process of creating the ranking Ra (each display information item Id) at predetermined time intervals, and individually setting each website Ws displaying the ranking Ra and each address information item A.

As illustrated in FIG. 2, the distribution device 14 includes the distribution control portion 51, a distribution operation portion 52, the distribution communication portion 53, a distribution display portion 54, and a distribution storage portion 55. In Embodiment 1, the distribution device 14 is a computer in which a program is stored in the distribution storage portion 55. The program may be stored in an internal memory 51a of the distribution control portion 51.

The distribution control portion 51 integrally executes the following respective processes based on the program stored in the distribution storage portion 55 or the built-in internal memory 51a. The respective processes include the distribution information creating process of creating the above ranking Ra (each display information item Id), and individually setting each website Ws displaying the ranking Ra and each address information item A and a distribution process of the website Ws in response to the request based on the address information item A from each receiving terminal 13. The distribution information creating process may automatically create and set with the data acquired through the distribution communication portion 53, or may create and set according to the operation to the distribution operation portion 52 while using the data. In response to the request of the website (including website Ws) based on the address information item (including the address information item A) from each receiving terminal 13, the distribution process acquires the website with the address information item, and distributes the website to the receiving terminal 13. In the receiving terminal 13, the ranking Ra (each display information item Id) with the address information item A can be thereby displayed on the terminal display portion 44, under the control of the terminal control portion 41 (refer to FIGS. 4, 6).

The distribution control portion 51 includes an operation of displaying, on the distribution display portion 54a, a screen for various setting with the distribution operation portion 52. The distribution control portion 51 appropriately executes the above-described each operation (control) based the program stored in the distribution storage portion 55 (internal memory 51a) or based on the operation to the distribution operation portion 52.

The distribution operation portion 52 is used to create the ranking Ra (each display information item Id) and is used for the operation of individual setting of each website Ws and each address information item A. In Embodiment 1, this distribution operation portion 52 is a keyboard connected to a computer or a pointing device such as a mouse. The distribution operation portion 52 may be constituted by the distribution display portion 54 with a touch panel.

The distribution communication portion 53 can appropriately acquire and distribute (output) data from an external device connected to the distribution device 14, an internal device built-in the distribution device 14, and a server connected to a network. The data to be acquired includes data (the number of received votes V) for creating the ranking Ra (each display information item Id). The distribution communication portion 53 can exchange data with the receiving terminal 13 (terminal control portion 41) through the terminal communication portion 45 and the controller 12 (arithmetic control portion 31) through the control communication portion 33. The data to be exchanged includes the address information item (including the address information item A) from each receiving terminal 13 and the website (website Ws (including ranking Ra (each display information item Id)) (refer to FIG. 2)) to each receiving terminal 13.

The distribution display portion 54 is a liquid crystal display, and displays the ranking Ra (each display information item Id) under the control of the distribution control portion 51. The distribution storage portion 55 stores readable various data and programs under the control of the distribution control portion 51. In Embodiment 1, the distribution storage portion 55 stores a program for constituting the information providing system 10 with the distribution device 14, the transmitter 11, the controller 12, and each receiving terminal 13. The distribution storage portion 55 stores an application for creating the ranking Ra (each display information item Id) and an application for individually setting each website Ws and each address information item A. The distribution storage portion 55 appropriately stores each ranking Ra (each display information item Id) and the website Ws and the address information item A corresponding to each ranking Ra.

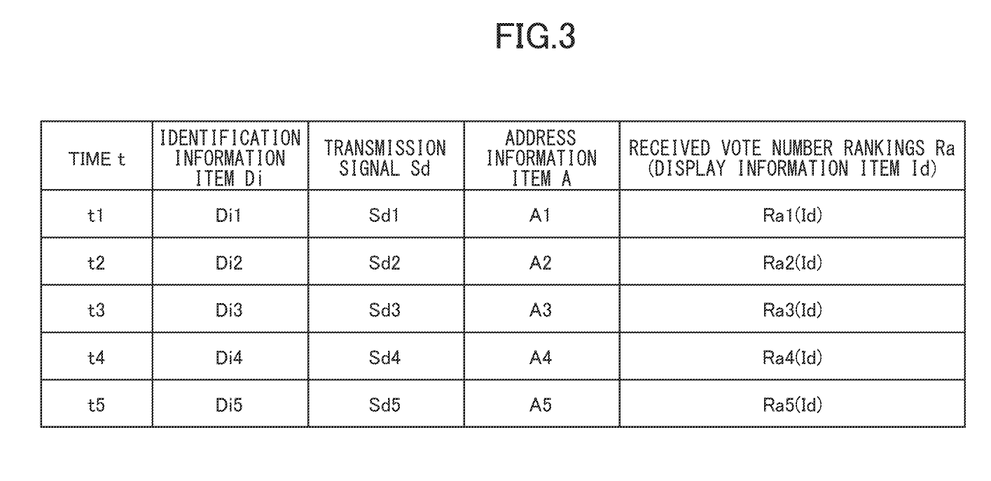

Next, one example of setting a plurality of rankings Ra as the display information items Id, and linking the address information item A of each website Ws displaying the ranking Ra to the identification information item Di set in the transmitter 11 is described with reference to FIG. 3. As this example includes a plurality of times t, identification information items Di, transmission signals Sd, address information items A, and rankings Ra (display information items Id), n (n is a natural number of one or more) is added to the end of each reference number when individually representing these.

At first, a plurality of identification information items Di is previously set in the transmitter 11, as described above. In this example, five identification information items Di are set. Upon inputting the transmission operation Od from the controller 12 (time t1), the transmitter 11 transmits (output) the transmission signal Sd1 in which the first identification information item Di1 is encoded, and then transmits (output) the transmission signals Sd2 to Sd5, in order, in which the identification information items Di2 to Di 5 are encoded, respectively, at the times t2 to t5, at predetermined time intervals (timing of transmission operation Od). The time intervals and the number of set identification information items Di are previously sent (output) to the controller 12 and the distribution device 14.

The distribution device 14 creates, as the display information items Id (Id1 to Id5), the information items (rankings Ra) on the order of the number of received votes V of each entrant (each performer P) for distributing in order at the times t1 to t5 in accordance with the setting of the transmitter 11 (distribution information creating process). In this example, the ranking RA1 which is distributed at the time t1 is the information item for informing the distribution of the information items on the order of the number of received votes V of each entrant (each performer P), as illustrated in FIG. 4. The rankings (Ra2 to Ra5) which are distributed in order at the times t2 to t5 are the information items showing the order of the number of received votes V of each entrant (each performer P) totaled at each time, as illustrated in FIGS. 5, 6. The distribution device 14 sets the websites Ws (Ws1 to Ws5) displaying the respective rankings Ra (Ra1 to Ra5) and the address information items A (A1 to A5), and send these to the controller 12.

The controller 12 sequentially links the address information item A (A1 to A5) corresponding to each ranking Ra (Ra1 to Ra5) to each identification information item Di (Di1 to Di5), in order to distribute the address information items A (A1 to A5) in order at the times t1 to t5. Each transmission signal Sd (each identification information item Di) which is transmitted (output) from the receiving terminal 13 is thereby linked to the address information item A (A1 to A5) of the each ranking Ra (Ra1 to Ra5) set in the distribution device 14. When the receiving terminal 13 sends the identification information item Di (Di1 to Di5) in which the transmission signal Sd is decoded the controller 12 sends the address information item A (A1 to A5) linked to the identification information item Di to the receiving terminal 13. In this case, the receiving terminal 13 acquires the transmission signals Sd1 to Sd5 in order with a time, and acquires the identification information items Di1 to Di5 in order. The receiving terminal 13 can therefore acquire the address information item A according to the time t of acquiring the identification information item Di (transmission signal Sd), and can display the ranking Ra according to the time t on the terminal display portion 44.

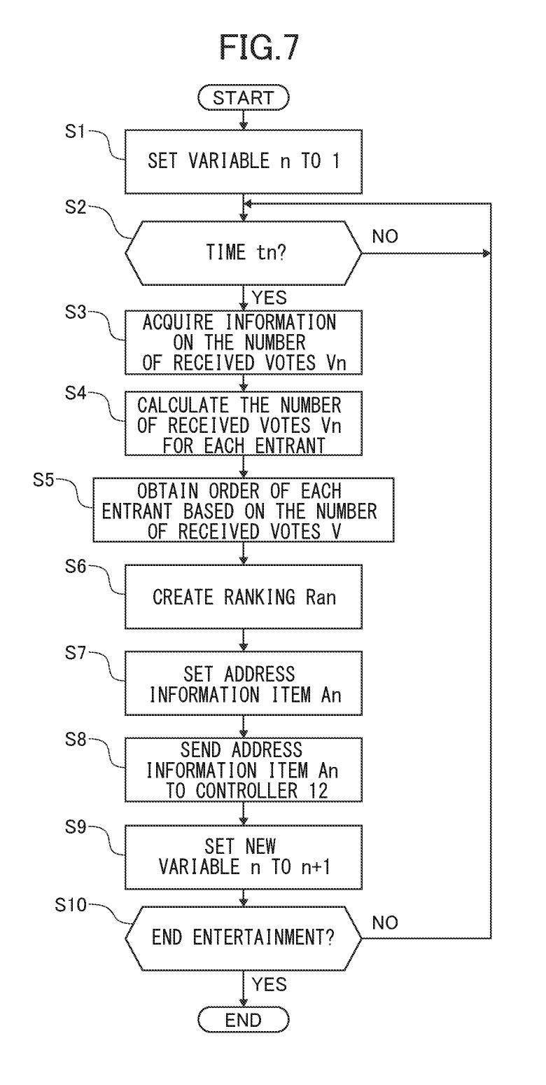

Next, one example of the distribution information creating process (application) which is executed by the distribution control portion 51 of the distribution device 14 of the information providing system 10 is described with reference to FIG. 7. The distribution control portion 51 executes the distribution information creating process by acquiring the information item on the number of received votes V of each entrant (each performer P). The information item on the number of received votes V can be acquired from the place (theater Th) where the entertainment is held and a website for totaling the votes and for selling goods relating to the entertainment. The information item on the number of received votes V may be acquired by the input of the distribution operation portion 52. FIG. 7 is a flowchart showing the distribution information creating process as one example which is executed by the distribution control portion 51 (distribution device 14) of Embodiment 1. Each step of the process is hereinafter described. This flowchart starts upon the activation of the above-described application.

In Step S1, the variable n is set to 1 (n=1). Then, the process proceeds to Step S2. This variable n indicates the order of the rankings Ra to be created. Namely, the variable n is used count a time corresponding to each identification information item D1 among the time to when each identification information item D1 set in the transmitter 11 is sent (output). In Step S1, the variable n is 1.

In Step S2, it is determined whether the time is the time tn or not. In the case of YES, the process proceeds to Step S3, and in the case of NO, Step S2 is repeated. In Step S2, it is determined whether the time is the time tn or not with the time interval of each identification information item Di set in the transmitter 11. In addition, when the transmission operation Od is executed by the controller 12, it is determined as YES even though the time is not the time tn. In this case, the next time tn is determined with the time interval set in the transmitter 11 with the time of the transmission operation Od as a standard.

In Step S3, the information item on the number of received votes Vn at the time tn is acquired. Then, the process proceeds to Step S4. In Step S3, the information item on the number of received votes Vn at the time tn is acquired through the distribution communication portion 53 or the distribution operation portion 52. In Embodiment 1, as the information item for informing the distribution of the information item (refer to FIG. 4) on the order of the number of received votes Vn of each entrant (each performer P) is firstly created as described above, the information item on the number of votes Vn is not acquired in Step S3 when n=1. In Embodiment 1, when n=1, the process proceeds to Step S6 without executing the following Steps S4, S5.

In Step S4, the number of received votes Vn for each entrant (in this example, performer P) is calculated. Then, the process proceeds to Step S5. In Step S4, the number of received votes Vn for each entrant (performer P) is calculated based on the information item on the number of received votes Vn acquired at Step S3. In this calculation, when the number of votes is the number of received votes V, the number of votes for each entrant (performer P) is simply totaled. Moreover, when the sales of the goods are the number of received votes V, the number of sales for each entrant (performer P) is simply totaled, or the point according to the number of sales and the sales amount for each entrant (performer P) is simply totaled. Furthermore, when the number of votes and the sales of the goods are the number of received votes V, the point according to the number of votes and the sales of the goods for each entrant (performer P) is totaled.

In Step S5, the order of each entrant (each performer P) based on the number of received votes Vn is obtained. Then, the process proceeds to Step S6. In this Step S5, the order of the entrant (performer P) is obtained according to the number of received votes Vn for each entrant (performer P) calculated in Step S4.

In Step S6, the ranking Ran as the display information item Id displaying the order obtained in Step S5 is created. Then, the process proceeds to Step S7. In Step S6, the ranking Ran (FIGS. 4 to 6) displaying the order of the entrant (performer P) obtained in Step S5 is created. In Embodiment 1, when n=1, the ranking Ran is the information item for informing the distribution of the information item on the order of the number of received votes V for each entrant (each performer P), as illustrated in FIG. 4. The point as the number of received votes V is described. In Embodiment 1, the ranking Ran when n is equal to two or more, as illustrated in FIGS. 5, 6, shows the order based on the number of received votes Vn. The ranking Ran illustrated in FIGS. 5, 6 shows, on the left end, the order, on the right side of the left end, the name (natural number of 1 or more is added after P) of the entrant (performer P), and, on the right side of the name of the entrant, the number of received votes Vn (in Embodiment 1, points according to the number of votes and the sales of the goods) acquired by the corresponding entrant (performer P). In Embodiment 1, the ranking Ran when n is equal to three or more, as illustrated in FIG. 6, displays, on the right end (right side of the number of received votes Vn), a change from the previous order. Steps S4 to S6 may be automatically executed based on the data acquired in Step S3, or may be executed according to the operation to the distribution operation portion 52 while using the data.

In Step S7, the address information item An of the ranking Ran is set. Then, the process proceeds to Step S8. In Step S7, the address information item An and the website Wsn displaying the ranking Ran created in Step S6 are set, and these are stored in the distribution storage portion 55. In Step S7, the website Wsn and the address information item An may be automatically set, or may be set according to the operation to the distribution operation portion 52.

In Step S8, the address information item An set in Step S7 is sent to the controller 12, and the process proceeds to Step S9. In Step S8, the address information item An set in Step S7 is combined with the variable n and sent (output) to the controller 12 (the arithmetic control portion 31) via the distribution communication portion 53 and the control communication portion 33.

In Step S9, n+1 is set as a new variable n, and the process proceeds to Step S10. In Step S9, a new variable n (n=n+1) is set by adding 1 to the variable n (current value) to create a next ranking Ra since the ranking Ra has created and sent (output) to the controller 12 from Step S4 to Step S8.

In Step S10, it is determined whether the entertainment has ended or not. The distribution information creating process is terminated in the case of YES, or the process returns to Step S2 in the case of NO. In Step S10, it is determined whether the target entertainment (show Dr in Embodiment 1) has ended or not. This determination is made by being at the preset ending time of the entertainment (show Dr) or by being input a signal indicating the end from the distribution operation portion 52 and/or the distribution communication portion 53.

Through the distribution information creating process shown in FIG. 7, the distribution control portion 51 creates the ranking Ran based on the number of received votes Vn for each entrant (performer P) at each time t, and sets the website Wsn and the address information item An. The distribution storage portion 55 stores the website Wsn and the address information item An, and the address information item An is combined with the variable n to be sent (output) to the arithmetic control portion 31. Note that the creating process is not limited to Embodiment 1, and a creating process different from the process shown in FIG. 7 may be adopted as long as the ranking Ran is created and the address information item An is set. The controller 12 acquires the address information item An of the ranking Ran at each time t, and the distribution device 14 can distribute the corresponding ranking Ran relative to a demand based on the address information item An from each receiving terminal 13.

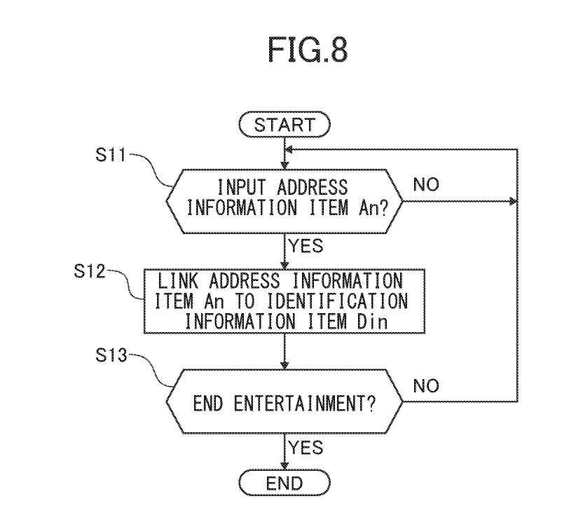

Next, an example of the linking process (its application) executed in the arithmetic control portion 31 of the controller 12 in the information providing system 10 will be described with reference to FIG. 8. The arithmetic control portion 31 executes the linking process by acquiring the address information item An of the ranking Ran at each time t. Such an acquisition may be made by a collective input to the control storage portion 35 and/or the internal memory 31a via the control communication portion 33 as described above, or by an individual input by the control operation portion 32. In the example shown in FIG. 8, the input is sequentially performed via the control communication portion 33. FIG. 8 shows, as one example, a flowchart of a linking process that is executed by the arithmetic control portion 31 (the controller 12) according to Embodiment 1. Each of steps will be described hereinafter. The flowchart is started by launching the application.

In Step S11, it is determined whether the address information item An has been input or not. The process proceeds to Step S1 in the case of YES, or Step S11 is repeated in the case of NO. In Step S11, it is determined whether the address information item An is input from the distribution device 14 via the control communication portion 33.

In Step S12, the identification information item Din and the address information item An input in Step S11 are linked and then the process proceeds to Step S13. In Step S12, the address information item An input from the distribution device 14 is linked to the identification information item Din having the variable n, and the control storage portion 35 stores the linked information items.

In Step S13, it is determined whether the entertainment has ended or not. This linking process is terminated in the case of YES, or the process returns to Step S11 in the case of NO. In Step S13, it is determined whether the target entertainment (show Dr in Embodiment 1) has ended or not. This determination is performed by being at the preset ending time of the entertainment (show Dr) or by receiving a signal indicating the end input from the control operation portion 32 and/or the control communication portion 33.

When the arithmetic control portion 31 acquires the address information item An from the distribution device 14 (the distribution control portion 51) by the linking process shown in FIG. 8, an identification information item Din having the variable n is linked to the address information item An and the control storage portion 35 stores them. Note that the linking process is not limited to Embodiment 1, and a linking process different from the one shown in the FIG. 8 may be adopted as long as the address information item An is linked to the identification information item Din as described above. The transmitter 11 transmits, in order from the time tn, the transmission signal Sdn obtained by encoding the identification information item Din. Thereby, the controller 12 can link the transmission signal Sdn transmitted by the transmitter 11 in order from the time tn to the address information item An indicating the ranking Ran at the time tn. When the identification information item Din is sent from the receiving terminal 13 as described above, the controller 12 can send the linked address information item An to the receiving terminal 13.

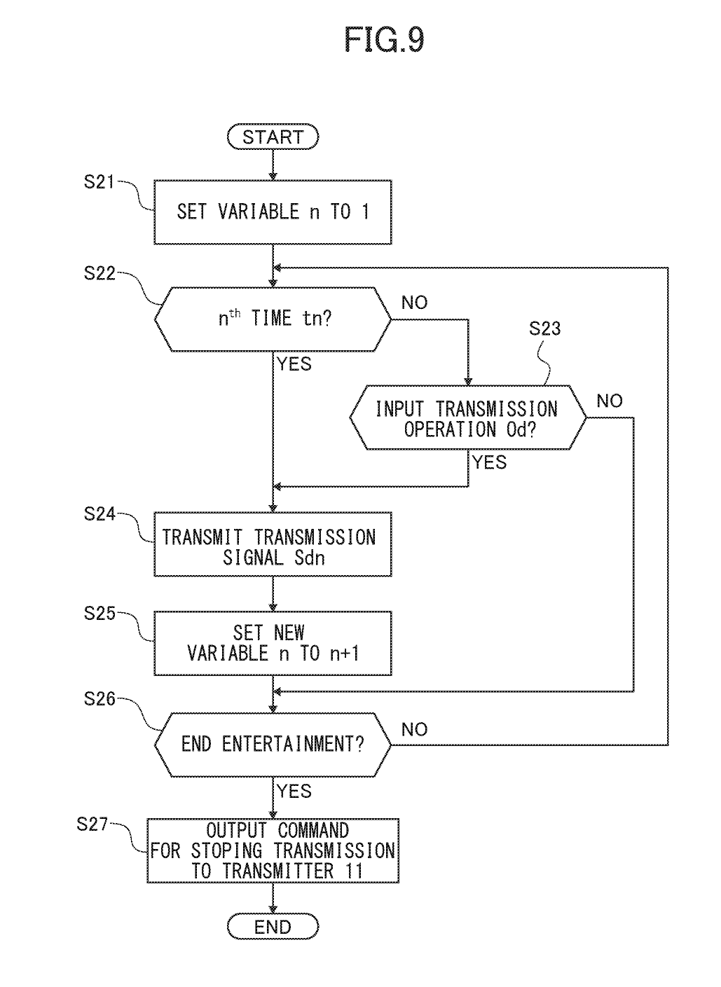

Next, an example of the transmission process (its application) executed in the transmission control portion 21 of the transmitter 11 will be described. The transmission process is a process in which the transmitter 11 (the transmission output portion 23) transmits (outputs) the transmission signal Sd. The transmission process will be described with reference to FIG. 9. FIG. 9 shows, as one example, a flowchart of the transmission process that is executed by the transmission control portion 21 (the transmitter 11) according to Embodiment 1. Each of steps will be described hereinafter. The flowchart starts when the application for the transmission process is launched in the transmitter 11 and the transmission operation Od is input from the controller 12.

In Step S21, the variable n is set to 1 (n=1), and the process proceeds to Step S22. The variable n is used for counting the order of the time t at which the transmission signal Sd is transmitted, and the variable n is set to 1 in Step S21.

In Step S22, it is determined whether the time is n^{th} time tn or not. The process proceeds to Step S24 in the case of YES, or the process proceeds to Step S23 in the case of NO. In Step S22, it is determined whether it is the n^{th} time tn or not. In other words, it is determined whether the set time interval has elapsed or not from n−1^{th} time t. In the Step S22 which is the first step since the transmission process starts, the time is the first time tn so that it is determined as YES, or then the process proceeds to Step S23.

In Step S23, it is determined whether the transmission operation Od has been input or not. The process proceeds to Step S24 in the case of YES, or the process proceeds to Step S26 in the case of NO. In Step S22, it is determined whether the transmission operation Od has been input from the controller 12 via the control communication portion 33 and the transmission communication portion 22.

In Step S24, the transmission signal Sdn set at the time tn is transmitted (output), and then the process proceeds to Step S25. In Step S24, the transmission signal Sdn obtained by encoding the identification information item Din set at the time to (n^{th}) is transmitted (output) from the transmission output portion 23 (the transmission process).

In Step S25, n+1 is set as a new variable n, and then the process proceeds to Step S26. In Step S25, a variable n (n=n+1) is set by adding 1 to the variable n (current value) to transmit (output) the transmission signal Sd set at next time t since the transmission signal Sdn has been transmitted (output) in Step S24.

In Step S26, it is determined whether the entertainment has ended or not. The process proceeds to Step S27 in the case of YES, or the process returns to Step S22 in the case of NO. In Step S26, it is determined whether the target entertainment (show Dr in Embodiment 1) has ended or not. This determination is made by being at the preset ending time of the entertainment (show Dr), by being input a signal indicating the end from the transmission communication portion 22, or by carrying out an operation for stopping the drive in the transmitter 11 or an operation for terminating the transmission process.

In Step S27, a command to stop the transmission is output to the transmitter 11, and then the transmission process is terminated.

In the transmission process shown in FIG. 9, the transmission output portion 23 transmits the transmission signal Sdn corresponding to the preset identification information item Din at the preset time tn (time interval) in a predetermined order. Further, the transmission output portion 23 immediately transmits the transmission signal Sd corresponding to the time tn upon receiving the transmission operation Od from the control operation portion 32 of the controller 12 even when it is not at the time tn. Each of the receiving terminals 13 receives the transmission signal Sd.

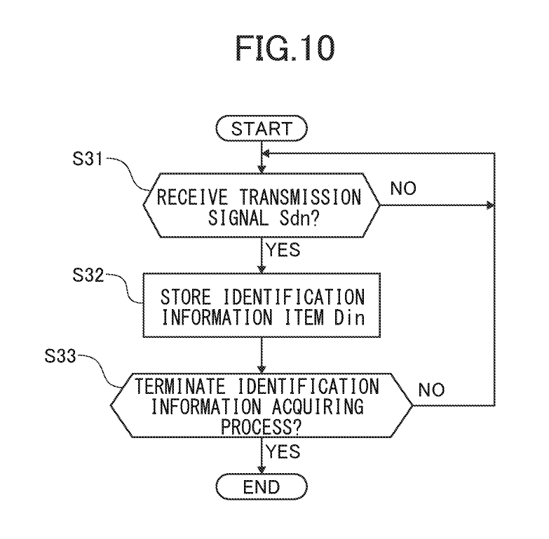

Next, an example of an identification information acquiring process (its application) executed in the terminal control portion 41 of the receiving terminal 13 will be described. The identification information acquiring process is a process for acquiring the identification information item Di from the transmission signal Sd transmitted by the transmitter 11. The process will be described with reference to FIG. 10. FIG. 10 shows, as one example, a flowchart of the identification information acquiring process that is executed by the terminal control portion 41 (the receiving terminal 13) according to Embodiment 1. Each step will be described hereinafter. The flowchart starts when the application for the identification information acquiring process is launched in the receiving terminal 13.

In Step S31, it is determined whether the transmission signal Sdn has been received or not. The process proceeds to Step S32 in the case of YES, or Step S31 is repeated in the case of NO. In Step S31, it is determined whether the receiving portion 42 of the receiving terminal 13 has received the transmission signal Sdn or not.

In Step S32, the terminal storage portion 46 stores the identification information item Din that indicates the transmission signal Sdn received in Step S31, and the process proceeds to Step S33. In Step S32, the received transmission signal Sdn is decoded to the identification information item Din, and the identification information item Din is stored in the terminal storage portion 46. Note that in Step S32, the identification information item Din is not stored in the terminal storage portion 46 when the transmission signal Sdn received in Step S31 has already stored in the terminal storage portion 46. Alternatively, the transmission signal Sdn may not be received in Step S31 instead of not being stored.

In Step S33, it is determined whether the identification information acquiring process is to be terminated or not. The identification information acquiring process is terminated in the case of YES, or the process returns to Step S31 in the case of NO. In Step S33, the process returns to Step S31 to continue the acquiring identification information item Di when the application for the identification information acquiring process continues, and the acquisition of the identification information item Di is terminated when the application is terminated. The continuation of the application is determined by the fact that the operation to terminate the application is not carried out, or by checking the presence of the continuation. Alternatively, the continuation may be determined by the fact that the target entertainment (show Dr in Embodiment 1) has not ended as the distribution information creating process in the distribution control portion 51 (see FIG. 7), the linking process in the arithmetic control portion 31 (see FIG. 8), and the transmission process (see FIG. 9) in the transmission control portion 21.

By the identification information acquiring process shown in FIG. 10, each receiving terminal 13 (the terminal control portion 41) acquires the plurality of the identification information items Di indicated by the transmission signals Sd transmitted from the transmitter 11, and the terminal storage portion 46 stores the identification information items Di. Each receiving terminal 13 (the terminal control portion 41) is capable of acquiring the corresponding address information item A by using each identification information item Di stored in the terminal storage portion 46.

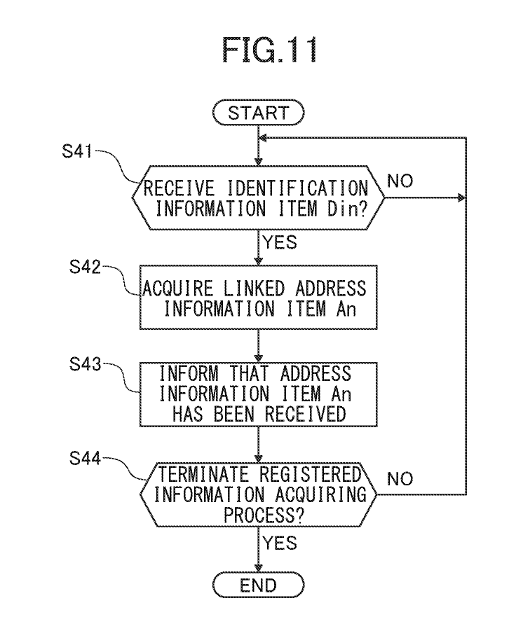

Next, an example of a registered information acquiring process (its application) that is executed by the terminal control portion 41 of the receiving terminal 13 will be described. The registered information acquiring process is to acquire from the controller 12 (the arithmetic control portion 31) each address information item A linked to each acquired identification information item Di. The registered information acquiring process will be described with reference to FIG. 11. FIG. 11 shows, as one example, a flowchart of the registered information acquiring process that is executed by the terminal control portion 41 (the receiving terminal 13) according to Embodiment 1. Each step will be described hereinafter. The flowchart starts when the application for the registered information acquiring process is launched. Note that, the launch of the application is basically performed simultaneously with the identification information acquiring process.

In Step S41, it is determined whether the identification information item Din has been received or not. The process proceeds to Step S42 in the case of YES, or Step S41 is repeated in the case of NO. In Step S41, it is determined whether the identification information item Din has been acquired (stored (memorized) in the terminal storage portion 46) or not by the identification information acquiring process (see FIG. 10), and the process is repeated until the identification information item Din is acquired.

In Step S42, the address information item An, to which the acquired identification information item Din is linked, is acquired, and the process proceeds to Step S43. In Step S42, the arithmetic control portion 31 of the controller 12 is accessed via the terminal communication portion 45 to acquire from the arithmetic control portion 31 the address information item An which is linked to the identification information item Din acquired in the identification information acquiring process, and the linked information items are stored in the terminal storage portion 46.

In Step S43, the acquisition of the address information item An is informed, and the process proceeds to Step S44. In Step S43, the acquisition of at least one address information item An is informed. This information may be carried out by displaying letters or icons which indicate the acquisition, outputting sound, or vibrating. In Step S43, in Embodiment 1, icons are displayed and each of the icons (the address information item A) is put in a condition to be selected. Each of the icons indicates the acquisition for each acquired address information item An. When the plurality of address information items An are acquired, the information items may be arranged in chronological order and displayed on the terminal display portion 44, only the latest address information item A may be displayed on the terminal display portion 44, or one of the address information items may be selectably displayed on the terminal display portion 44. Alternatively, in Step S43, simple contents of the display information item Id, which is indicated by the corresponding address information item A in each icon, may be displayed. For example, the contents may be acquired from the arithmetic control portion 31 when the address information item An from the arithmetic control portion 31 (the controller 12) is acquired, or the contents may be acquired together with the transmission signal Sdn from the transmitter 11 (the transmission output portion 23) if possible. In Step S43, the web browser is launched when any one of the icons is selected, and Uniform Resource Locator (URL) indicated by the address information item An corresponding to the selected icon is passed to the web browser to access the URL. Then, the ranking Ran (the display information item Id) in the website Wsn indicated by the URL is displayed on the terminal display portion 44. Note that in Step S43, access to the website Wsn may not necessarily be made. In the registered information acquiring process, when the terminal display portion 44 displays each icon in Step S43, the terminal display portion 44 continuously displays it until the process is terminated.

In Step S44, it is determined whether the registered information acquiring process is to be terminated or not. The registered information acquiring process is terminated in the case of YES, and the process returns to Step S41 in the case of NO. In Step S44, it is determined whether an operation for ending the acquisition of the address information item A linked to each identification information item Di (operation for ending the application, for example) has been carried out or not.

By the registered information acquiring process shown in FIG. 11, each receiving terminal 13 (the terminal control portion 41) can acquire at the time tn the address information item An linked to the identification information item Din transmitted from the transmitter 11, and acquire the ranking Ran based on the aggregate results up to the time tn to display the rankings on the terminal display portion 44.

Next, an example of how each attendance Au who visits the theater Th to see a show Dr, which is an example of the entertainment, participates in the show Dr (entertainment) with the information providing system 10 will be described. The information providing system 10 gives a notification to each attendance Au to launch the application corresponding to the system in the receiving terminal 13 each attendance has. The install rate of the application in the receiving terminal 13 of the attendance Au can be increased if the application can be acquired at the entrance and the like of the theater Th, for example.

In the information providing system 10, the distribution device 14 executes the distribution information creating process, the controller 12 executes the linking process, the transmitter 11 executes the transmission process, and the receiving terminal 13 executes the identification information acquiring process and the registered information acquiring process. In other words, the process proceeds through Steps S1, S2, S3, S4, S5, S6, S7, and S8 in the flowchart shown in FIG. 7, and the distribution device 14 (the distribution control portion 51) sets the ranking Ra1 corresponding to the time t1, the website Ws1 and the address information item A1, and sends the address information item A1 to the controller 12. Then, the process proceeds from Steps S11 to S12 in the flowchart shown in FIG. 8, and the controller 12 (the arithmetic control portion 31) links the identification information item Di1 at the time t1 to the address information item A1. The process proceeds through Steps S21, S22, and S24 in the flowchart shown in FIG. 9, and the transmitter 11 (the transmission control portion 21) transmits a transmission signal Sd1 obtained by encoding the identification information item Di1 at the time t1. The receiving terminal 13 (the terminal control portion 41) receives the transmission signal Sd1 transmitted in Step S31 in the flowchart shown in FIG. 10. Then, the process proceeds to Step S32, and the identification information item Di1 indicated by the transmission signal Sd1 is stored in the terminal storage portion 46. The process proceeds through Steps S41, S42, and S43 in the flowchart shown in FIG. 11, and the receiving terminal 13 (the terminal control portion 41) acquires the address information item A1 linked to the received identification information item Di1 and displays a selectable icon to inform the acquisition of the address information item A1. The selection of the icon in the receiving terminal 13 accesses to the website Ws1 indicated by the address information item A1 corresponding to the icon and the website Ws1 is displayed on the terminal display portion 44. As shown in FIG. 4, the ranking Ra1 at the time t1 is displayed on the terminal display portion 44 in the receiving terminal 13. In Embodiment 1, the notification to distribute information on the rankings based on the number of received votes Vn to each entrant (each performer P) is displayed. As a result, in the information providing system 10, the ranking Ra1 as the display information item Id set at the time t1 can be provided to the receiving terminal 13 of each attendance Au.

Subsequently, in the information providing system 10, the process proceeds through Steps S8, S9, S10, and S1 in the flowchart shown in FIG. 7, and the distribution device 14 repeats the above described steps. The process proceeds through Steps S12, S13, and S11 in the flowchart shown in FIG. 8, and the controller 12 repeats the above described steps. The process proceeds through Steps S25, S26, and S22 in the flowchart shown in FIG. 9, and the transmitter 11 repeats the above described steps. The process proceeds through Steps S32, S33, and S31 in the flowchart shown in FIG. 10, and the receiving terminal 13 repeats the above described steps. The process proceeds through Steps S43, S44, and S41 in the flowchart shown in FIG. 11, and the receiving terminal 13 repeats the above described steps. As a result, in the information providing system 10, the ranking Ran as the display information item Idn set at the time to can be provided to the receiving terminal 13 of each attendance Au (see FIG. 5), and the ranking Ran +1 as the display information item Idn set at the time tn+1 can be provided to the receiving terminal 13 of each attendance Au (see FIG. 6). In this way, in the information providing system 10, the ranking Ran can be continually updated and provided to the receiving terminal 13 of each attendance Au until the entertainment ends.

According to the information providing system 10 which is an embodiment of the information providing system in the present disclosure, following operations and effects can be achieved.

According to the information providing system 10, each receiving terminal 13 of people at a place for an entertainment event (show Dr in Embodiment 1) can acquire and display the latest ranking Ra. Therefore, according to the information providing system 10, each attendance Au not only sees the entertainment (show Dr), but also participates in the entertainment, which makes the entertainment more attractive. Specifically, each attendance Au votes to a performer and/or buys goods related to the performer in the entertainment when the attendance Au likes the performance (play, song, and the like) by the performer P (entrant). Then, the information providing system 10 converts such actions by the attendances into the number of received votes V, and the ranking of each performer based on the number of received votes V is displayed on a real-time basis in the receiving terminal 13 of each attendance Au. Accordingly, each attendance Au can recognize in real time that his or her action affects the latest ranking Ra, and each attendance Au can participate in the entertainment by voting and/or buying goods. In this way, the attendance Au can participate in the entertainment by the information providing system 10 and the entertainment can be more attractive with the participation of the attendances Au. Further, each of the performers can recognize the reaction of the attendances Au firsthand as the rankings Ra, which increases the motivation of the performers and accordingly improves the quality of the entertainment.

Further, in the information providing system 10, the address information item A relative to the latest ranking Ra is sent to the receiving terminal 13 of each attendance Au at a predetermined time interval (each the time t) so that each attendance Au can be provided with the latest ranking Ra and does not need to search the ranking. Therefore, the information providing system 10 can actively encourage people who do not conventionally visit the website Ws due to a troublesome task such as searching, and/or people who are not interested in rankings Ra to participate in the entertainment (show Dr) and can make the entertainment more attractive.

Moreover, the information providing system 10 makes the entertainment (show Dr) more attractive by informing the ranking Ra which changes in real time so as to raise interest in an action to increase the number of received votes V for the ranking Ra while in a place to hold an entertainment (the theater Th to hold the show Dr in this embodiment) for attendances Au who are less interested in such an action. As a result, the information providing system 10 can promote an action to increase the number of received votes V by each attendance Au, which makes the entertainment more interesting.

With the information providing system 10, promoters who hold the entertainment (show Dr) can recognize the reaction of each attendance Au firsthand as the rankings Ra and accordingly they appropriately and quickly have data such as the popularity of each entrant (performer P). As a result, according to the information providing system 10, the promoters can promptly obtain effective information to plan a strategy for advertisements and/or merchandises in the entertainment (show Dr).

The information providing system 10 can arbitrarily set the number of received votes V which decides the ranking of each entrant (performer P) to create the rankings Ra. Accordingly, the information providing system 10 can make the entertainment more attractive by setting the number of received votes V depending on the type and location of the entertainment. Further, the voting to ballot boxes installed in the place (theater Th) in case of voting and the sales at stores in the place in case of the sales of the goods can be reflected to the number of received votes V, which makes the entertainment more interesting.

Even when it is not at the predetermined time t, the information providing system 10 can transmit (output) the transmission signal Sd from the transmitter 11 by performing the transmission operation Od, so that the receiving terminal 13 of each attendance Au can acquire the rankings Ra. Therefore, the information providing system 10 can provide the rankings Ra to correspond to sudden changes that the target entertainment (show Dr) has not progressed as originally scheduled, for example.

In the information providing system 10, the distribution device 14 sets each ranking Ra and each address information item A, and the controller 12 links each address information item A to each identification information item Di. Further, in the information providing system 10, the transmitter 11 transmits (outputs) each transmission signal Sd obtained by encoding each identification information item Di, and each receiving terminal 13 acquires each transmission signal Sd and each ranking Ra (the display information item Id) from the corresponding address information item A. Accordingly, the information providing system 10 can provide in real time each ranking Ra, which corresponds to each of various events or entertainments held in the place (theater Th) by installing the transmitters 11 in the place in relation to the single controller 12 and the distribution device 14. In other words, the information providing system 10 can make each entertainment more attractive by preparing the transmitters 11 with the corresponding application and using each transmitter 11 installed in different places as well as the single controller 12 and the distribution device 14 simultaneously in the various entertainments.

In the information providing system 10, the distribution device 14 sets each ranking Ra and each address information item A, the controller 12 links each address information item A to each identification information item Di, and only each transmission signal Sd can be transmitted between the transmitter 11 and each receiving terminal 13. Accordingly, in the information providing system 10, the information amount of the transmission signal Sd transmitted from the transmitter 11 can be reduced, ability required for each receiving terminal 13 to which each ranking Ra is provided can be minimized, and more people can easily acquire a plurality of information items.

Therefore, the information providing system 10 according to the present disclosure can make the entertainment (show Dr) more attractive.

Note that the information providing system and the program according to the present disclosure have been described in Embodiment 1. However, the present disclosure is not limited to Embodiment 1 and another information providing system and a program may be adopted as long as the information providing system includes a distribution device configured to distribute a display information item corresponding to an address information item, a controller configured to link the address information item to an identification information item, a transmitter in a place where an entertainment is held, the transmitter configured to transmit a transmission signal encoded from the identification information item, and a receiving terminal configured to receive the transmission signal transmitted from the transmitter and decode the transmission signal into the identification information item, wherein the display information item indicates a ranking based on a number of received votes an entrant for the entertainment has received, wherein the distribution device is configured to update, at predetermined time intervals, the display information item that indicates the ranking based on the number of received votes and to set the address information item to correspond to a plurality of display information items, and wherein the controller is configured to send to the receiving terminal the address information item corresponding to a latest display information item and linked to the identification information item when the controller receives the identification information item from the receiving terminal, or a program for an information providing system including a distribution device configured to distribute a display information item corresponding to an address information item, a controller configured to link the address information item to an identification information item, a transmitter in a place where an entertainment is held, the transmitter configured to transmit a transmission signal encoded from the identification information item, and a receiving terminal configured to receive the transmission signal transmitted from the transmitter and decode the transmission signal into the identification information item, wherein the display information item displays a ranking based on a number of received votes an entrant for the entertainment has received, wherein the program is configured to make the distribution device realize a function for updating, at predetermined time intervals, the display information item that indicates the ranking based on the number of received votes and for setting the address information item to correspond to a plurality of display information items, and to make the controller realize a function for sending to the receiving terminal the address information item corresponding to a latest display information item and linked to the identification information item when the controller receives the identification information item from the receiving terminal.

In Embodiment 1, the transmitter 11 transmits (outputs) in order the transmission signal Sd obtained by encoding the preset identification information items Di. However, the present disclosure is not limited to the configuration shown in Embodiment 1. Another configuration may be adopted as long as the controller 12 can send the address information item A corresponding to the latest ranking Ra (the display information item Id) to each receiving terminal 13. As an example, the transmission signal Sd transmitted by the transmitter 11 may be modified. In this case, the controller 12 may set the identification information items Di and link each of the identification information items Di to each address information item A, the controller 12 or the transmitter 11 may create the transmission signal Sd by encoding each identification information item Di, and the transmitter 11 may transmit each transmission signal Sd. Such a transmitter 11 may be a dedicated terminal, a smart phone (mobile phone), a personal computer, a touch pad, and the like, for example. As another example, a plurality of transmitters 11 may be provided to transmit (output) the transmission signal Sd and operated in order. As yet another example, a single transmitter 11 may be provided to transmit (output) the transmission signal Sd, and the controller 12 may rewrite and set the address information item A corresponding to the latest ranking Ra (the display information item Id) relative to each identification information item Di corresponding to the transmission signal Sd. In other words, when the controller 12 acquires the address information item A of the latest ranking Ra (the display information item Id) from the distribution device 14, the controller 12 links the address information item A to the single transmission signal Sd so that the latest ranking Ra (the display information item Id) may be accessed with the address information item A transmitted to each receiving terminal 13.

Further, the address information item A and the website Ws, which shows the ranking Ra every time the ranking is updated, are set in Embodiment 1. However, this configuration is not limited to Embodiment 1. Another configuration may be adopted as long as the controller 12 can send the address information item A corresponding to the latest ranking Ra (the display information item Id) to each receiving terminal 13. As an example of such a configuration, the website Ws and the address information item A may be fixed, and the ranking Ra (the display information item Id) to be displayed may be properly updated. In this case, a same effect as in Embodiment 1 can be achieved by informing the update of the ranking Ra at each time t, and by sending the fixed address information item A.

In Embodiment 1, the screen of the ranking Ra is shown in FIG. 4 to FIG. 6 as an example of the display information item Id. However, the screen is not limited to one shown in Embodiment 1. Other screens (configurations) may be adopted as long as the screen shows the ranking based on the number of received votes V each entrant (performer P) of the entertainment (show Dr) receives.

In Embodiment 1, the management frame of Beacon with the Bluetooth Low Energy wireless communication method is used for the transmission signal Sd transmitted from the transmitter 11. However, the above configuration is not limited to Embodiment 1. Other beacons, one having a similar function, or one in which a code reader can read a signal superimposed on sound (music and voice) may be adopted as long as transmission signal Sd which is obtained by encoding each identification information item Di is transmitted with a short range wireless communication. The superimposition of the sound may achieve a simpler configuration since the transmission signal Sd can be output from a sound outputting device so that it is unnecessary to provide the transmitter 11 only for outputting the transmission signal Sd.

The information providing system and the program according to the present disclosure have been described with reference to Embodiment 1. However, the specific configurations are not limited to ones shown in Embodiment 1, but design changes and additions should be permitted as long as they do not deviate from the gist of the present disclosure. Further, the number, positions, shapes and the like of the elements are not limited to ones shown in Embodiment 1, but suitable number, positions, shapes and the like may be properly selected for carrying out the present disclosure.

1. An information providing system comprising:
a distribution device configured to distribute a display information item corresponding to an address information item,
a controller configured to link the address information item to an identification information item,
a transmitter in a place where an entertainment is held, the transmitter configured to transmit a transmission signal encoded from the identification information item, and
a receiving terminal configured to receive the transmission signal from the transmitter and decode the transmission signal into the identification information item,
wherein the display information item indicates a ranking based on a number of received votes an entrant for the entertainment has received,
wherein the distribution device is configured to update, at predetermined time intervals, the display information item that indicates the ranking based on the number of received votes and to set the address information item to correspond to a plurality of display information items, and
wherein the controller is configured to send to the receiving terminal the address information item corresponding to a latest display information item and linked to the identification information item when the controller receives the identification information item from the receiving terminal.

2. The information providing system according to claim 1,
wherein the number of received votes is the number of votes to the entrant in the entertainment.

3. The information providing system according to claim 1,
wherein the number of received votes is a numerical value based on sales of goods related to the entrant in the entertainment.

4. The information providing system according to claim 1,
wherein the number of received votes is a numerical value based on the number of votes to the entrant in the entertainment and sales of goods related to the entrant in the entertainment.

5. The information providing system according to claim 1,
wherein the controller is configured to link the identification information item that is indicated by the transmission signal the transmitter transmits to the address information item corresponding to the latest display information item.

6. The information providing system according to claim 1,
wherein the controller is configured to set a plurality of identification information items to be linked to a plurality of address information items, respectively,
wherein the transmitter is configured to transmit in order a plurality of transmission signals encoded from the plurality of identification information items, and
wherein the controller is configured to link the identification information item that is indicated by a latest transmission signal the transmitter transmits to the address information item corresponding to the latest display information item.

7. (canceled)

8. The information providing system according to claim 2,
wherein the controller is configured to link the identification information item that is indicated by the transmission signal the transmitter transmits to the address information item corresponding to the latest display information item.

9. The information providing system according to claim 3,
wherein the controller is configured to link the identification information item that is indicated by the transmission signal the transmitter transmits to the address information item corresponding to the latest display information item.

10. The information providing system according to claim 4,
wherein the controller is configured to link the identification information item that is indicated by the transmission signal the transmitter transmits to the address information item corresponding to the latest display information item.

11. The information providing system according to claim 2,
wherein the controller is configured to set a plurality of identification information items to be linked to a plurality of address information items, respectively,
wherein the transmitter is configured to transmit in order a plurality of transmission signals encoded from the plurality of identification information items, and
wherein the controller is configured to link the identification information item that is indicated by a latest transmission signal the transmitter transmits to the address information item corresponding to the latest display information item.

12. The information providing system according to claim 3,
wherein the controller is configured to set a plurality of identification information items to be linked to a plurality of address information items, respectively,
wherein the transmitter is configured to transmit in order a plurality of transmission signals encoded from the plurality of identification information items, and
wherein the controller is configured to link the identification information item that is indicated by a latest transmission signal the transmitter transmits to the address information item corresponding to the latest display information item.

13. The information providing system according to claim 4,
wherein the controller is configured to set a plurality of identification information items to be linked to a plurality of address information items, respectively,
wherein the transmitter is configured to transmit in order a plurality of transmission signals encoded from the plurality of identification information items, and
wherein the controller is configured to link the identification information item that is indicated by a latest transmission signal the transmitter transmits to the address information item corresponding to the latest display information item.
